(19) United States
(12) Patent Application Publication
(10) Pub. No.: US 2015/0380786 A1
(43) Pub. Date: Dec. 31, 2015

(54) METAL-AIR BATTERY

(71) Applicants: Zongxuan Hong, Houston, TX (US); Cunxi Shen, Houston, TX (US); Aiying Chen, Xiapu (CN)

(72) Inventors: Zongxuan Hong, Houston, TX (US); Cunxi Shen, Houston, TX (US); Aiying Chen, Xiapu (CN)

(21) Appl. No.: 14/848,530

(22) Filed: Sep. 9, 2015

Related U.S. Application Data
(63) Continuation-in-part of application No. 13/669,005, filed on Nov. 5, 2012, now abandoned.

(51) Int. Cl. H01M 12/06

(52) U.S. Cl. CPC H01M 12/06

(57) ABSTRACT

A metal-air battery includes an anode portion comprising at least a metal gel and an electrolyte. A mesh screen is disposed on the anode portion. The mesh screen is configured for substantially holding the metal gel within the anode portion. A cathode portion includes at least a current carrier and a cathode catalyst. A separator is disposed between the anode portion and the cathode portion for mitigating leakage of the electrolyte. A gate device is disposed between the anode portion and the cathode portion. The gate device has an open state to enable a contact of the anode portion and the cathode portion for activating a generation of electrical power, and a closed state to separate the contact of the anode portion and the cathode portion to inhibit the generation of electrical power for storing the metal-air battery.

### CROSS-REFERENCE TO RELATED APPLICATIONS

The present Continuation in Part patent application claims priority benefit of the U.S. non provisional patent application Ser. No. 13/669,005, entitled “Metal-Air Battery System with Detachable Anode and Cathode Compartment”, Filed 5 Nov. 2012 under 35 U.S.C. 120, and further claims priority to U.S. provisional application for patent Ser. No. 61/589,625, entitled “Metal-Air Battery System With Detachable Anode And Cathode Compartments”, filed on 23 Jan. 2012, under 35 U.S.C. 119(e). The contents of these related applications are incorporated herein by reference for all purposes to the extent that such subject matter is not inconsistent herewith or limiting hereof.

### RELATED CO-PENDING U.S. PATENT APPLICATIONS

No applicable.

### FEDERALLY SPONSORED RESEARCH OR DEVELOPMENT

Not applicable.

### REFERENCE TO SEQUENCE LISTING, A TABLE, OR A COMPUTER LISTING APPENDIX

Not applicable.

### COPYRIGHT NOTICE

A portion of the disclosure of this patent document contains material that is subject to copyright protection by the author thereof. The copyright owner has no objection to the facsimile reproduction by anyone of the patent document or patent disclosure for the purposes of referencing as patent prior art, as it appears in the Patent and Trademark Office, patent file or records, but otherwise reserves all copyright rights whatsoever.

### FIELD OF THE INVENTION

One or more embodiments of the invention generally relate to metal-air battery systems. More particularly, the invention relates to a metal-air battery system with separable anode and cathode compartments.

### BACKGROUND OF THE INVENTION

The following background information may present examples of specific aspects of the prior art (e.g., without limitation, approaches, facts, or common wisdom) that, while expected to be helpful to further educate the reader as to additional aspects of the prior art, is not to be construed as limiting the present invention, or any embodiments thereof, to anything stated or implied therein or inferred thereupon.

Conventional metal-air batteries typically comprise of a cathode and an anode that are separated by a separator. The cathode in a metal-air battery typically comprises of oxygen, an electrode catalyst capable of converting oxygen into hydroxyl anions, and a current carrier. The anode in a metal-air battery typically comprises of a metal mixed with an electrolyte. When the battery generates electric power during use, oxygen from the air enters through openings in a compartment that holds the cathode. The electrode catalyst in the cathode then reduces the oxygen to produce hydroxide ions.

Generally, metal-air battery life can degrade both before and after use. Before typical operation, electrolyte from a metal-air battery's anode may leak through the separator between the anode and the cathode. Electrolyte that leaks into the cathode may saturate the cathode and degrade battery life. Additionally, battery life may degrade if electrolyte leaks through the anode compartment. During the storage and typical operation, water may penetrate separator and accumulate in the electrode catalyst. The reduction reaction activity will decrease as water builds up in the electrode catalyst, which negatively affects battery life and power.

The following is an example of a specific aspect in the prior art that, while expected to be helpful to further educate the reader as to additional aspects of the prior art, is not to be construed as limiting the present invention, or any embodiments thereof, to anything stated or implied therein or inferred thereupon. By way of educational background, another aspect of the prior art generally useful to be aware of is that a common metal-air battery design is a zinc-air battery.

Typically, openings in a zinc-air battery are typically sealed by an adhesive backed tab prior to use. The adhesive backed tab may preserve battery life by preventing mainly water from entering the cathode compartment before the battery is put into service. Battery degradation may still occur in zinc-air batteries from electrolyte leaking into the cathode or outside the anode compartment.

In view of the foregoing, it is clear that these traditional techniques are not perfect and leave room for more optimal approaches.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 illustrates an exemplary metal-air battery system, in accordance with an embodiment of the present invention;

FIG. 2 illustrates an exemplary metal-air battery system with an injection device, in accordance with an embodiment of the present invention;

FIG. 3 illustrates an exemplary metal-air battery system with a stirring device, in accordance with an embodiment of the present invention;

FIG. 4 illustrates an exemplary metal-air battery system with an adjustable gate, in accordance with an embodiment of the present invention;

FIG. 5 illustrates an exemplary metal-air battery with an adjustable gate and injection device, in accordance with an embodiment of the present invention;

FIG. 6 illustrates an exemplary metal-air battery with an adjustable gate and stirring device, in accordance with an embodiment of the present invention; and

FIG. 7 is a power storage analysis, in accordance with an embodiment of the present invention.

Unless otherwise indicated illustrations in the figures are not necessarily drawn to scale.

### DETAILED DESCRIPTION OF SOME EMBODIMENTS

The present invention is best understood by reference to the detailed figures and description set forth herein.

Embodiments of the invention are discussed below with reference to the Figures. However, those skilled in the art will readily appreciate that the detailed description given herein with respect to these figures is for explanatory purposes as the invention extends beyond these limited embodiments. For example, it should be appreciated that those skilled in the art will, in light of the teachings of the present invention, recognize a multiplicity of alternate and suitable approaches, depending upon the needs of the particular application, to implement the functionality of any given detail described herein, beyond the particular implementation choices in the following embodiments described and shown. That is, there are modifications and variations of the invention that are too numerous to be listed but that all fit within the scope of the invention. Also, singular words should be read as plural and vice versa and masculine as feminine and vice versa, where appropriate, and alternative embodiments do not necessarily imply that the two are mutually exclusive.

It is to be further understood that the present invention is not limited to the particular methodology, compounds, materials, manufacturing techniques, uses, and applications, described herein, as these may vary. It is also to be understood that the terminology used herein is used for the purpose of describing particular embodiments only, and is not intended to limit the scope of the present invention. It must be noted that as used herein and in the appended claims, the singular forms “a,” “an,” and “the” include the plural reference unless the context clearly dictates otherwise. Thus, for example, a reference to “an element” is a reference to one or more elements and includes equivalents thereof known to those skilled in the art. Similarly, for another example, a reference to “a step” or “a means” is a reference to one or more steps or means and may include sub-steps and subservient means. All conjunctions used are to be understood in the most inclusive sense possible. Thus, the word “or” should be understood as having the definition of a logical “or” rather than that of a logical “exclusive or” unless the context clearly necessitates otherwise. Structures described herein are to be understood also to refer to functional equivalents of such structures. Language that may be construed to express approximation should be so understood unless the context clearly dictates otherwise.

All words of approximation as used in the present disclosure and claims should be construed to mean “approximate,” rather than “perfect,” and may accordingly be employed as a meaningful modifier to any other word, specified parameter, quantity, quality, or concept. Words of approximation, include, yet are not limited to terms such as “substantial”, “nearly”, “almost”, “about”, “generally”, “largely”, “essentially”, “closely approximate”, etc.

As will be established in some detail below, is well settle law, as early as 1939, that words of approximation are not indefinite in the claims even when such limits are not defined or specified in the specification.

For example, see Ex parte Mallory, 52 USPQ 297, 297 (Pat. Off. Bd. App. 1941) where the court said “The examiner has held that most of the claims are inaccurate because apparently the laminar film will not be entirely eliminated. The claims specify that the film is “substantially” eliminated and for the intended purpose, it is believed that the slight portion of the film which may remain is negligible. We are of the view, therefore, that the claims may be regarded as sufficiently accurate.”

Note that claims need only “reasonably apprise those skilled in the art” as to their scope to satisfy the definiteness requirement. See Energy Absorption Sys., Inc. v. Roadway Safety Servs., Inc., Civ. App. 96-1264, slip op. at 10 (Fed. Cir. Jul. 3, 1997) (unpublished) Hybridtech v. Monoclonal Antibodies, Inc., 802 F.2d 1367, 1385, 231 USPQ 81, 94 (Fed. Cir. 1986), cert. denied, 480 U.S. 947 (1987). In addition, the use of modifiers in the claim, like “generally” and “substantial,” does not by itself render the claims indefinite. See Seattle Box Co. v. Industrial Crating & Packing, Inc., 731 F.2d 818, 828-29, 221 USPQ 568, 575-76 (Fed. Cir. 1984).

Moreover, the ordinary and customary meaning of terms like “substantially” includes “reasonably close to: nearly, almost, about”, connoting a term of approximation. See In re Frye, Appeal No. 2009-006013, 94 USPQ2d 1072, 1077, 2010 WL 889747 (B.P.A.I. 2010) Depending on its usage, the word “substantially” can denote either language of approximation or language of magnitude. Deering Precision Instruments, L.L.C. v. Vector Distribution Sys., Inc., 347 F.3d 1314, 1323 (Fed. Cir. 2003) (recognizing the “dual ordinary meaning of th[e] term [”substantially“] as connoting a term of approximation or a term of magnitude”). Here, when referring to the “substantially halfway” limitation, the Specification uses the word “approximately” as a substitute for the word “substantially” (Fact 4). (Fact 4). The ordinary meaning of “substantially halfway” is thus reasonably close to or nearly at the midpoint between the forwardmost point of the upper or outsole and the rearwardmost point of the upper or outsole.

Similarly, term ‘substantially’ is well recognize in case law to have the dual ordinary meaning of connoting a term of approximation or a term of magnitude. See Dana Corp. v. American Axle & Manufacturing, Inc., Civ. App. 04-1116, 2004 U.S. App. LEXIS 18265, *13-14 (Fed. Cir. Aug. 27, 2004) (unpublished). The term “substantially” is commonly used by claim drafters to indicate approximation. See Cordis Corp. v. Medtronic AVE Inc., 339 F.3d 1352, 1360 (Fed. Cir. 2003) (“The patents do not set out any numerical standard by which to determine whether the thickness of the wall surface is ‘substantially uniform.’ The term ‘substantially,’ as used in this context, denotes approximation. Thus, the walls must be of largely or approximately uniform thickness.”); see also Deering Precision Instruments, LLC v. Vector Distribution Sys., Inc., 347 F.3d 1314, 1322 (Fed. Cir. 2003); Epcon Gas Sys., Inc. v. Bauer Compressors, Inc., 279 F.3d 1022, 1031 (Fed. Cir. 2002). We find that the term “substantially” was used in just such a manner in the claims of the patents-in-suit: “substantially uniform wall thickness” denotes a wall thickness with approximate uniformity.

It should also be noted that such words of approximation as contemplated in the foregoing clearly limits the scope of claims such as saying ‘generally parallel’ such that the adverb ‘generally’ does not broaden the meaning of parallel. Accordingly, it is well settled that such words of approximation as contemplated in the foregoing (e.g., like the phrase ‘generally parallel’) envisions some amount of deviation from perfection (e.g., not exactly parallel), and that such words of approximation as contemplated in the foregoing are descriptive terms commonly used in patent claims to avoid a strict numerical boundary to the specified parameter. To the extent that the plain language of the claims relying on such words of approximation as contemplated in the foregoing are clear and uncontradicted by anything in the written description herein or the figures thereof, it is improper to rely upon the present written description, the figures, or the prosecution history to add limitations to any of the claim of the present invention with respect to such words of approximation as contemplated in the foregoing. That is, under such circumstances, relying on the written description and prosecution history to reject the ordinary and customary meanings of the words themselves is impermissible. See, for example, Liquid Dynamics Corp. v. Vaughan Co., 355 F.3d 1361, 69 USPQ2d 1595, 1600-01 (Fed. Cir. 2004). The plain language of phrase 2 requires a “substantial helical flow.” The term “substantial” is a meaningful modifier implying “approximate,” rather than “perfect.” In Cordis Corp. v. Medtronic AVE, Inc., 339 F.3d 1352, 1361 (Fed. Cir. 2003), the district court imposed a precise numeric constraint on the term “substantially uniform thickness.” We noted that the proper interpretation of this term was “of largely or approximately uniform thickness” unless something in the prosecution history imposed the “clear and unmistakable disclaimer” needed for narrowing beyond this simple-language interpretation. Id. In Anchor Wall Systems v. Rockwood Retaining Walls, Inc., 340 F.3d 1298, 1311 (Fed. Cir. 2003)” Id. at 1311. Similarly, the plain language of claim 1 requires neither a perfectly helical flow nor a flow that returns precisely to the center after one rotation (a limitation that arises only as a logical consequence of requiring a perfectly helical flow).

The reader should appreciate that case law generally recognizes a dual ordinary meaning of such words of approximation, as contemplated in the foregoing, as connoting a term of approximation or a term of magnitude; e.g., see Deering Precision Instruments, L.L.C. v. Vector Distrib. Sys., Inc., 347 F.3d 1314, 68 USPQ2d 1716, 1721 (Fed. Cir. 2003), cert. denied, 124 S. Ct. 1426 (2004) where the court was asked to construe the meaning of the term “substantially” in a patent claim. Also see Epcon, 279 F.3d at 1031 (“The phrase ‘substantially constant’ denotes language of approximation, while the phrase ‘substantially below’ signifies language of magnitude, i.e., not insubstantial.”). Also, see, e.g., Epcon Gas Sys., Inc. v. Bauer Compressors, Inc., 279 F.3d 1022 (Fed. Cir. 2002) (construing the terms “substantially constant” and “substantially below”); Zodiac Pool Care, Inc. v. Hoffinger Indus., Inc., 206 F.3d 1408 (Fed. Cir. 2000) (construing the term “substantially inward”); York Prods., Inc. v. Cent. Tractor Farm & Family Ctr., 99 F.3d 1568 (Fed. Cir. 1996) (construing the term “substantially the entire height thereof”); Tex. Instruments Inc. v. Cypress Semiconductor Corp., 90 F.3d 1558 (Fed. Cir. 1996) (construing the term “substantially in the common plane”). In conducting their analysis, the court instructed to begin with the ordinary meaning of the claim terms to one of ordinary skill in the art. Prima Tek, 318 F.3d at 1148. Reference to dictionaries and our cases indicates that the term “substantially” has numerous ordinary meanings. As the district court stated, “substantially” can mean “significantly” or “considerably.” The term “substantially” can also mean “largely” or “essentially.” Webster's New 20th Century Dictionary 1817 (1983).

Words of approximation, as contemplated in the foregoing, may also be used in phrases establishing approximate ranges or limits, where the end points are inclusive and approximate, not perfect; e.g., see AK Steel Corp. v. Sollac, 344 F.3d 1234, 68 USPQ2d 1280, 1285 (Fed. Cir. 2003) where it where the court said [W]e conclude that the ordinary meaning of the phrase “up to about 10%” includes the “about 10%” endpoint. As pointed out by AK Steel, when an object of the preposition “up to” is nonnumeric, the most natural meaning is to exclude the object (e.g., painting the wall up to the door). On the other hand, as pointed out by Sollac, when the object is a numerical limit, the normal meaning is to include that upper numerical limit (e.g., counting up to ten, seating capacity for up to seven passengers). Because we have here a numerical limit—“about 10%”—the ordinary meaning is that that endpoint is included.

In the present specification and claims, a goal of employment of such words of approximation, as contemplated in the foregoing, is to avoid a strict numerical boundary to the modified specified parameter, as sanctioned by Pall Corp. v. Micron Separations, Inc., 66 F.3d 1211, 1217, 36 USPQ2d 1225, 1229 (Fed. Cir. 1995) where it states “It is well established that when the term “substantially” serves reasonably to describe the subject matter so that its scope would be understood by persons in the field of the invention, and to distinguish the claimed subject matter from the prior art, it is not indefinite.” Likewise see Verve LLC v. Crane Cams Inc., 311 F.3d 1116, 65 USPQ2d 1051, 1054 (Fed. Cir. 2002). Expressions such as “substantially” are used in patent documents when warranted by the nature of the invention, in order to accommodate the minor variations that may be appropriate to secure the invention. Such usage may well satisfy the charge to “particularly point out and distinctly claim” the invention, 35 U.S.C. §112, and indeed may be necessary in order to provide the inventor with the benefit of his invention. In Andrew Corp. v. Gabriel Elecs. Inc., 847 F.2d 819, 821-22, 6 USPQ2d 2010, 2013 (Fed. Cir. 1988) the court explained that usages such as “substantially equal” and “closely approximate” may serve to describe the invention with precision appropriate to the technology and without intruding on the prior art. The court again explained in Ecolab Inc. v. Envirochem, Inc., 264 F.3d 1358, 1367, 60 USPQ2d 1173, 1179 (Fed. Cir. 2001) that “like the term ‘about,’ the term ‘substantially’ is a descriptive term commonly used in patent claims to ‘avoid a strict numerical boundary to the specified parameter, see Ecolab Inc. v. Envirochem Inc., 264 F.3d 1358, 60 USPQ2d 1173, 1179 (Fed. Cir. 2001) where the court found that the use of the term “substantially” to modify the term “uniform” does not render this phrase so unclear such that there is no means by which to ascertain the claim scope.

Similarly, other courts have noted that like the term “about,” the term “substantially” is a descriptive term commonly used in patent claims to “avoid a strict numerical boundary to the specified parameter.”; e.g., see Pall Corp. v. Micron Seps., 66 F.3d 1211, 1217, 36 USPQ2d 1225, 1229 (Fed. Cir. 1995); see, e.g., Andrew Corp. v. Gabriel Elecs. Inc., 847 F.2d 819, 821-22, 6 USPQ2d 2010, 2013 (Fed. Cir. 1988) (noting that terms such as “approach each other,” “close to,” “substantially equal,” and “closely approximate” are ubiquitously used in patent claims and that such usages, when serving reasonably to describe the claimed subject matter to those of skill in the field of the invention, and to distinguish the claimed subject matter from the prior art, have been accepted in patent examination and upheld by the courts). In this case, “substantially” avoids the strict 100% nonuniformity boundary.

Indeed, the foregoing sanctioning of such words of approximation, as contemplated in the foregoing, has been established as early as 1939, see Ex parte Mallory, 52 USPQ 297, 297 (Pat. Off. Bd. App. 1941) where, for example, the court said “the claims specify that the film is “substantially” eliminated and for the intended purpose, it is believed that the slight portion of the film which may remain is negligible. We are of the view, therefore, that the claims may be regarded as sufficiently accurate.” Similarly, In re Hutchison, 104 F.2d 829, 42 USPQ 90, 93 (C.C.P.A. 1939) the court said “It is realized that “substantial distance” is a relative and somewhat indefinite term, or phrase, but terms and phrases of this character are not uncommon in patents in cases where, according to the art involved, the meaning can be determined with reasonable clearness.”

Hence, for at least the forgoing reason, Applicants submit that it is improper for any examiner to hold as indefinite any claims of the present patent that employ any words of approximation.

Unless defined otherwise, all technical and scientific terms used herein have the same meanings as commonly understood by one of ordinary skill in the art to which this invention belongs. Preferred methods, techniques, devices, and materials are described, although any methods, techniques, devices, or materials similar or equivalent to those described herein may be used in the practice or testing of the present invention. Structures described herein are to be understood also to refer to functional equivalents of such structures. The present invention will now be described in detail with reference to embodiments thereof as illustrated in the accompanying drawings.

From reading the present disclosure, other variations and modifications will be apparent to persons skilled in the art. Such variations and modifications may involve equivalent and other features which are already known in the art, and which may be used instead of or in addition to features already described herein.

Although Claims have been formulated in this Application to particular combinations of features, it should be understood that the scope of the disclosure of the present invention also includes any novel feature or any novel combination of features disclosed herein either explicitly or implicitly or any generalization thereof, whether or not it relates to the same invention as presently claimed in any Claim and whether or not it mitigates any or all of the same technical problems as does the present invention.

Features which are described in the context of separate embodiments may also be provided in combination in a single embodiment. Conversely, various features which are, for brevity, described in the context of a single embodiment, may also be provided separately or in any suitable subcombination. The Applicants hereby give notice that new Claims may be formulated to such features and/or combinations of such features during the prosecution of the present Application or of any further Application derived therefrom.

References to “one embodiment,” “an embodiment,” “example embodiment,” “various embodiments,” “some embodiments,” “embodiments of the invention,” etc., may indicate that the embodiment(s) of the invention so described may include a particular feature, structure, or characteristic, but not every possible embodiment of the invention necessarily includes the particular feature, structure, or characteristic. Further, repeated use of the phrase “in one embodiment,” or “in an exemplary embodiment,” “an embodiment,” do not necessarily refer to the same embodiment, although they may. Moreover, any use of phrases like “embodiments” in connection with “the invention” are never meant to characterize that all embodiments of the invention must include the particular feature, structure, or characteristic, and should instead be understood to mean “at least some embodiments of the invention” includes the stated particular feature, structure, or characteristic.

References to “user”, or any similar term, as used herein, may mean a human or non-human user thereof. Moreover, “user”, or any similar term, as used herein, unless expressly stipulated otherwise, is contemplated to mean users at any stage of the usage process, to include, without limitation, direct user(s), intermediate user(s), indirect user(s), and end user(s). The meaning of “user”, or any similar term, as used herein, should not be otherwise inferred or induced by any pattern(s) of description, embodiments, examples, or referenced prior-art that may (or may not) be provided in the present patent.

References to “end user”, or any similar term, as used herein, is generally intended to mean late stage user(s) as opposed to early stage user(s). Hence, it is contemplated that there may be a multiplicity of different types of “end user” near the end stage of the usage process. Where applicable, especially with respect to distribution channels of embodiments of the invention comprising consumed retail products/services thereof (as opposed to sellers/vendors or Original Equipment Manufacturers), examples of an “end user” may include, without limitation, a “consumer”, “buyer”, “customer”, “purchaser”, “shopper”, “enjoyer”, “viewer”, or individual person or non-human thing benefiting in any way, directly or indirectly, from use of or interaction, with some aspect of the present invention.

In some situations, some embodiments of the present invention may provide beneficial usage to more than one stage or type of usage in the foregoing usage process. In such cases where multiple embodiments targeting various stages of the usage process are described, references to “end user”, or any similar term, as used therein, are generally intended to not include the user that is the furthest removed, in the foregoing usage process, from the final user therein of an embodiment of the present invention.

Where applicable, especially with respect to retail distribution channels of embodiments of the invention, intermediate user(s) may include, without limitation, any individual person or non-human thing benefiting in any way, directly or indirectly, from use of, or interaction with, some aspect of the present invention with respect to selling, vending, Original Equipment Manufacturing, marketing, merchandising, distributing, service providing, and the like thereof.

References to “person”, “individual”, “human”, “a party”, “animal”, “creature”, or any similar term, as used herein, even if the context or particular embodiment implies living user, maker, or participant, it should be understood that such characterizations are sole by way of example, and not limitation, in that it is contemplated that any such usage, making, or participation by a living entity in connection with making, using, and/or participating, in any way, with embodiments of the present invention may be substituted by such similar performed by a suitably configured non-living entity, to include, without limitation, automated machines, robots, humanoids, computational systems, information processing systems, artificially intelligent systems, and the like. It is further contemplated that those skilled in the art will readily recognize the practical situations where such living makers, users, and/or participants with embodiments of the present invention may be in whole, or in part, replaced with such non-living makers, users, and/or participants with embodiments of the present invention. Likewise, when those skilled in the art identify such practical situations where such living makers, users, and/or participants with embodiments of the present invention may be in whole, or in part, replaced with such non-living makers, it will be readily apparent in light of the teachings of the present invention how to adapt the described embodiments to be suitable for such non-living makers, users, and/or participants with embodiments of the present invention. Thus, the invention is thus to also cover all such modifications, equivalents, and alternatives falling within the spirit and scope of such adaptations and modifications, at least in part, for such non-living entities.

Headings provided herein are for convenience and are not to be taken as limiting the disclosure in any way.

The enumerated listing of items does not imply that any or all of the items are mutually exclusive, unless expressly specified otherwise.

It is understood that the use of specific component, device and/or parameter names are for example only and not meant to imply any limitations on the invention. The invention may thus be implemented with different nomenclature/terminology utilized to describe the mechanisms/units/structures/components/devices/parameters herein, without limitation. Each term utilized herein is to be given its broadest interpretation given the context in which that term is utilized.

Terminology. The following paragraphs provide definitions and/or context for terms found in this disclosure (including the appended claims):

“Comprising.” This term is open-ended. As used in the appended claims, this term does not foreclose additional structure or steps. Consider a claim that recites: “A memory controller comprising a system cache . . . . ” Such a claim does not foreclose the memory controller from including additional components (e.g., a memory channel unit, a switch).

“Configured To.” Various units, circuits, or other components may be described or claimed as “configured to” perform a task or tasks. In such contexts, “configured to” or “operable for” is used to connote structure by indicating that the mechanisms/units/circuits/components include structure (e.g., circuitry and/or mechanisms) that performs the task or tasks during operation. As such, the mechanisms/unit/circuit/component can be said to be configured to (or be operable) for perform(ing) the task even when the specified mechanisms/unit/circuit/component is not currently operational (e.g., is not on). The mechanisms/units/circuits/components used with the “configured to” or “operable for” language include hardware—for example, mechanisms, structures, electronics, circuits, memory storing program instructions executable to implement the operation, etc. Reciting that a mechanism/unit/circuit/component is “configured to” or “operable for” perform(ing) one or more tasks is expressly intended not to invoke 35 U.S.C. .sctn.112, sixth paragraph, for that mechanism/unit/circuit/component. “Configured to” may also include adapting a manufacturing process to fabricate devices or components that are adapted to implement or perform one or more tasks.

“Based On.” As used herein, this term is used to describe one or more factors that affect a determination. This term does not foreclose additional factors that may affect a determination. That is, a determination may be solely based on those factors or based, at least in part, on those factors. Consider the phrase “determine A based on B.” While B may be a factor that affects the determination of A, such a phrase does not foreclose the determination of A from also being based on C. In other instances, A may be determined based solely on B.

The terms “a”, “an” and “the” mean “one or more”, unless expressly specified otherwise.

Unless otherwise indicated, all numbers expressing conditions, concentrations, dimensions, and so forth used in the specification and claims are to be understood as being modified in all instances by the term “about.” Accordingly, unless indicated to the contrary, the numerical parameters set forth in the following specification and attached claims are approximations that may vary depending at least upon a specific analytical technique.

The term “comprising,” which is synonymous with “including,” “containing,” or “characterized by” is inclusive or open-ended and does not exclude additional, unrecited elements or method steps. “Comprising” is a term of art used in claim language which means that the named claim elements are essential, but other claim elements may be added and still form a construct within the scope of the claim.

As used herein, the phase “consisting of” excludes any element, step, or ingredient not specified in the claim. When the phrase “consists of” (or variations thereof) appears in a clause of the body of a claim, rather than immediately following the preamble, it limits only the element set forth in that clause; other elements are not excluded from the claim as a whole. As used herein, the phase “consisting essentially of” limits the scope of a claim to the specified elements or method steps, plus those that do not materially affect the basis and novel characteristic(s) of the claimed subject matter.

With respect to the terms “comprising,” “consisting of,” and “consisting essentially of,” where one of these three terms is used herein, the presently disclosed and claimed subject matter may include the use of either of the other two terms. Thus in some embodiments not otherwise explicitly recited, any instance of “comprising” may be replaced by “consisting of” or, alternatively, by “consisting essentially of.”

Devices or system modules that are in at least general communication with each other need not be in continuous communication with each other, unless expressly specified otherwise. In addition, devices or system modules that are in at least general communication with each other may communicate directly or indirectly through one or more intermediaries.

A description of an embodiment with several components in communication with each other does not imply that all such components are required. On the contrary a variety of optional components are described to illustrate the wide variety of possible embodiments of the present invention.

As is well known to those skilled in the art many careful considerations and compromises typically must be made when designing for the optimal manufacture of a commercial implementation any system, and in particular, the embodiments of the present invention. A commercial implementation in accordance with the spirit and teachings of the present invention may configured according to the needs of the particular application, whereby any aspect(s), feature(s), function(s), result(s), component(s), approach(es), or step(s) of the teachings related to any described embodiment of the present invention may be suitably omitted, included, adapted, mixed and matched, or improved and/or optimized by those skilled in the art, using their average skills and known techniques, to achieve the desired implementation that addresses the needs of the particular application.

In the following description and claims, the terms “coupled” and “connected,” along with their derivatives, may be used. It should be understood that these terms are not intended as synonyms for each other. Rather, in particular embodiments, “connected” may be used to indicate that two or more elements are in direct physical or electrical contact with each other. “Coupled” may mean that two or more elements are in direct physical or electrical contact. However, “coupled” may also mean that two or more elements are not in direct contact with each other, but yet still cooperate or interact with each other.

It is to be understood that any exact measurements/dimensions or particular construction materials indicated herein are solely provided as examples of suitable configurations and are not intended to be limited in any way. Depending on the needs of the particular application, those skilled in the art will readily recognize, in light of the following teachings, a multiplicity of suitable alternative implementation details.

Some embodiments of the present invention and variations thereof, relate to separable anode and cathode compartments in a metal-air battery. In one embodiment of the invention, a gate system controls the separation of the anode and cathode compartments of a metal-air battery.

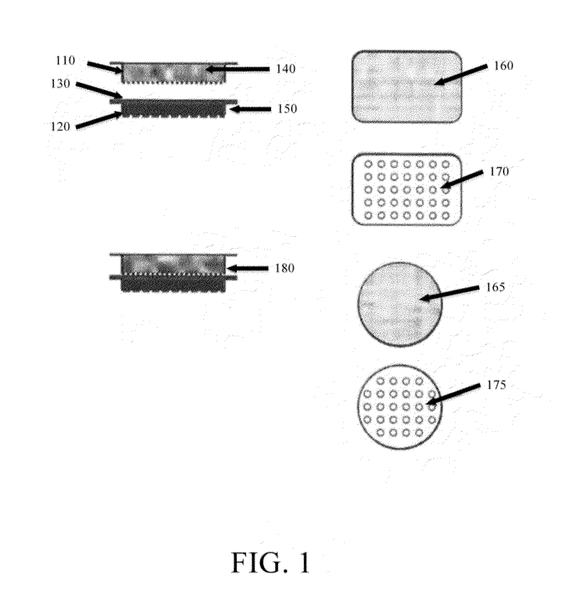

FIG. 1 illustrates an exemplary metal-air battery system, in accordance with an embodiment of the present invention. The metal-air battery system comprises of a detachable anode compartment 110, a detachable cathode compartment 120, and a separator 130. Detachable anode compartment 110 comprises of a rectangular mesh screen 160 and a metal gel 140 with electrolyte. Metal gel 140 may be any metal gel such as, but not limited to, zinc gel, and aluminum gel. The electrolyte in metal gel 140 may be any electrolyte such as, but not limited to, potassium hydroxide, sodium hydroxide and lithium hydroxide. Rectangular mesh screen 160 is located at the bottom of detachable anode compartment 110, with respect to FIG. 1. In another embodiment of the present invention, rectangular mesh screen 160 may be a circular mesh screen 165. Detachable cathode compartment 120 comprises of a rectangular bottom with openings 170 and a cathode material 150. In another embodiment of the present invention, rectangular bottom with openings 170 may be a circular bottom with openings 175. Cathode material 150 comprises of a current carrier and a cathode catalyst that converts oxygen to hydroxyl anions.

During typical operation, detachable anode compartment 110 and detachable cathode compartment 120 are coupled to form metal-air battery 180. Mesh screen 160 at the bottom of detachable anode compartment 110 is in direct contact with separator 130 and a cathode catalyst in detachable cathode compartment 120. An electrochemical reaction generating electric power will occur when detachable anode compartment 110 and detachable cathode compartment 120 are coupled.

When the metal-air battery system is not in operation, the metal-air battery system may be put in a storage mode. In storage mode, detachable anode compartment 110 and detachable cathode compartment 120 are separated. Metal gel 140 in the detachable anode compartment 110 is held in the detachable anode compartment 110 by rectangular mesh screen 160. Electrolyte in metal gel 140 should not leak through rectangular mesh screen 160 and saturate separator 130 and/or cathode material 150.

It may be appreciated to a person with ordinary skill in the art that separator 130 may be part of detachable anode compartment 110 and/or detachable cathode compartment 120 to prevent electrolyte leakage of specific metal gels. The separator may be a physical barrier such as, but not limited to, cellulous, such as paper; nonwoven fibers, such as cotton, nylon, polyesters; polymer films, such as, but not limited to, polyethylene, polypropylene, poly (tetrafluoroethylene), and polyvinyl chloride. Another embodiment of the invention may have separators made with different designs and/or materials to from an application unique anode and/or cathode.

It may be appreciated to a person with ordinary skill in the art that separator 130 may be used to contain metal gel 140 for detachable anode compartment 110 or cathode material 150 for detachable cathode compartment 120. Another embodiment of the invention may have a separator replacing rectangular mesh screen 160.

It may be appreciated to a person with ordinary skill in the art that detachable anode compartment 110, detachable cathode compartment 120, the comprising components of detachable anode compartment 110, and the comprising components of detachable cathode compartment 120 are not limited to only rectangular and circular shapes. Another embodiment of the invention may implement any shape such as, but not limited to, a triangular shape.

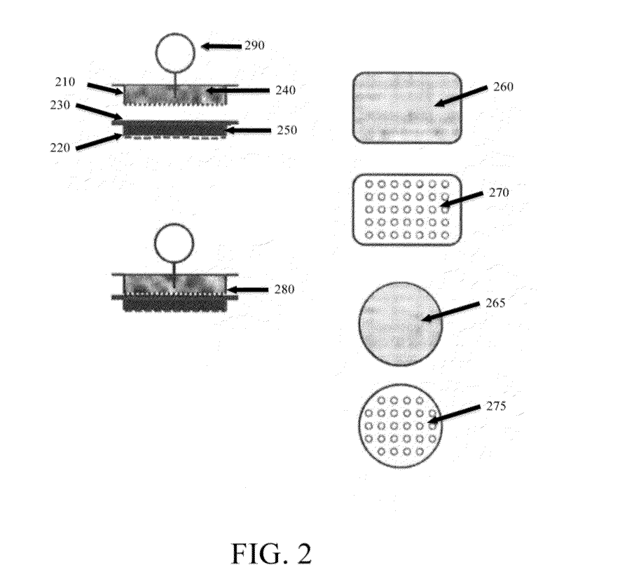

FIG. 2 illustrates an exemplary metal-air battery system with an injection device, in accordance with an embodiment of the present invention. The metal-air battery system with injection device comprises of a detachable anode compartment 210, a detachable cathode compartment 220, a separator 230, and an injection device 290. Detachable anode compartment 210 comprises of a rectangular mesh screen 260 and a metal gel 240 with electrolyte. Metal gel 240 may be any metal gel such as, but not limited to, zinc gel and aluminum gel. The electrolyte in metal gel 240 may be any electrolyte such as, but not limited to, potassium hydroxide, sodium hydroxide, and lithium hydroxide. Rectangular mesh screen 260 is located at the bottom of detachable anode compartment 210, with respect to FIG. 2. In another embodiment of the present invention, rectangular mesh screen 260 may be a circular mesh screen 265. Detachable cathode compartment 220 comprises of a rectangular bottom with openings 270 and a cathode material 250. In another embodiment of the present invention, rectangular bottom with openings 270 may be a circular bottom with openings 275. Cathode material 250 comprises of a current carrier and a cathode catalyst that converts oxygen to hydroxyl anions.

During typical operation, detachable anode compartment 210 and detachable cathode compartment 220 are coupled to form metal-air battery 280. Mesh screen 260 at the bottom of detachable anode compartment 210 is in direct contact with separator 230 and a cathode catalyst in detachable cathode compartment 220. An electrochemical reaction generating electric power will occur when detachable anode compartment 210 and detachable cathode compartment 220 are coupled.

Metal gel 240 may lose water and/or electrolytes over time or during typical operation, which may negatively impact the rate of electric power generation. Injection device 290 may be used to add a desirable amount of water and/or electrolyte to metal gel 240 through an injection port in detachable anode compartment 210.

It may be appreciated to a person with ordinary skill in the art that injection device 290 is not limited to adding water and/or an electrolyte solution. Another embodiment of the invention may inject a metal gel into detachable anode compartment 210. Still another embodiment of the invention may remove material from detachable anode compartment 210.

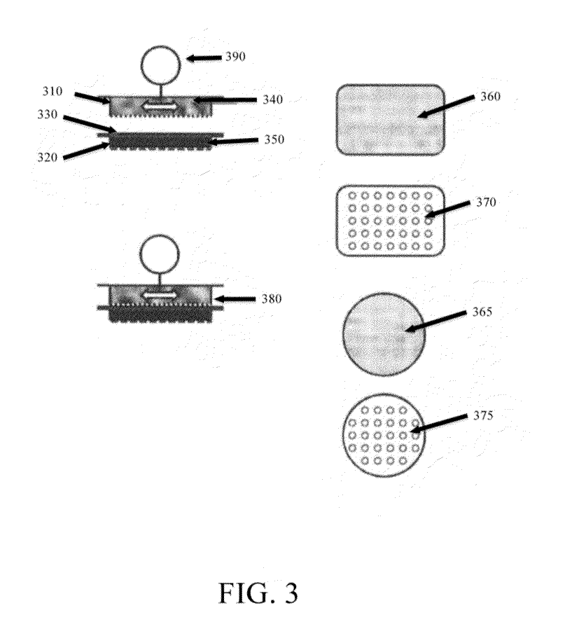

FIG. 3 illustrates an exemplary metal-air battery system with a stirring device, in accordance with an embodiment of the present invention. The metal-air battery system with stirring device comprises of a detachable anode compartment 310, a detachable cathode compartment 320, a separator 330, and a stirring device 390. Detachable anode compartment 310 comprises of a rectangular mesh screen 360 and a metal gel 340 with electrolyte. Metal gel 340 may be any metal gel such as, but not limited to, zinc gel and aluminum gel. The electrolyte in metal gel 340 may be any electrolyte such as, but not limited to, potassium hydroxide, sodium hydroxide, and lithium hydroxide. Rectangular mesh screen 360 is located at the bottom of detachable anode compartment 310, with respect to FIG. 3. In another embodiment of the present invention, rectangular mesh screen 360 may be a circular mesh screen 365. Detachable cathode compartment 320 comprises of a rectangular bottom with openings 370 and a cathode material 350. In another embodiment of the present invention, rectangular bottom with openings 370 may be a circular bottom with openings 375. Cathode material 350 comprises of a current carrier and a cathode catalyst that converts oxygen to hydroxyl anions.

During typical operation, detachable anode compartment 310 and detachable cathode compartment 320 are coupled to form metal-air battery 380. Mesh screen 360 at the bottom of detachable anode compartment 310 is in direct contact with separator 330 and a cathode catalyst in detachable cathode compartment 320. An electrochemical reaction generating electric power will occur when detachable anode compartment 310 and detachable cathode compartment 320 are coupled.

Electric power generation of metal-air battery 380 may diminish over time. Stirring device 390 may be used to induce movement of metal gel 340 when desirable. Movement of metal gel 340 may improve electric power generation of metal-air battery 380.

It may be appreciated to a person with ordinary skill in the art that stirring device 390 may be virtually any shape or design capable of inducing movement such as, but not limited to, a propeller and, a vibration tip. Another embodiment of the present invention may have stirring device 390 as a fan head connected to an electric motor. Still another embodiment of the present invention may have an injector to simultaneously stir and inject material into detachable anode compartment 310.

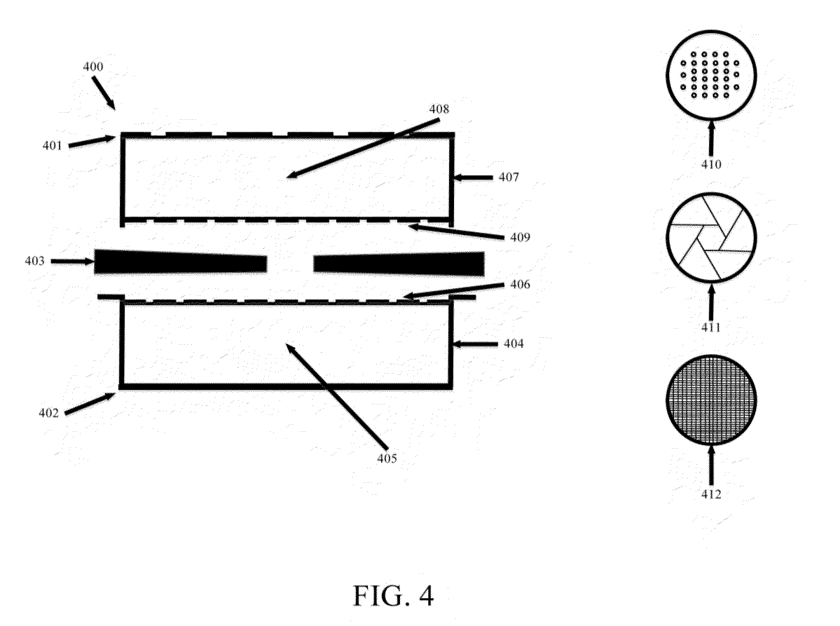

FIG. 4 illustrates an exemplary metal-air battery system with an adjustable gate, in accordance with an embodiment of the present invention. In the present embodiment, metal-air battery 400 comprises of an anode 401, a cathode 402, and a gate 403. Anode 401 comprises of a detachable anode compartment 404, a metal gel 405, and a mesh screen 406. Cathode 402 comprises of a detachable cathode compartment 407, an electrode catalyst 408, and a mesh screen 409. Cathode top view 410, with respect to FIG. 4, of detachable cathode compartment 407 depicts openings in detachable cathode compartment 407 to allow oxygen to diffuse to the electrode catalyst 408. Gate 403 comprises of a gate in a shutter design that separates anode 401 and cathode 402. In some embodiments, gate 403 may comprise, plastic, polymers, or and non-conductive material. In some other embodiments, gate 403 may comprise a material that may have some conductivity. Gate top view 411, with respect to FIG. 4, depicts gate 403 in a partially open position. Mesh view 412 depicts a top-down view of mesh screen 406 and 409.

During typical operation, gate 403 is opened to allow for anode 401 and cathode 402 to couple. In some embodiments, gate 403 may be partially opened as long as there is contact between anode 401 and cathode 402. While anode 401 and cathode 402 are coupled, oxygen from the air will diffuse through openings in the top of detachable cathode compartment 407 and react with electrode catalyst 408. Electric power is generated by an electrochemical reaction between the anode 401 and the cathode 402. Detachable anode compartment 404 and detachable cathode compartment 407 may be modularly removed from metal-air battery 400. Additionally, the contents of detachable anode 404 and detachable cathode compartment 407 may be replaced.

When metal-air battery 400 is not in operation, metal-air battery 400 may be put into a storage mode. Gate 403 may be closed to separate the anode 401 and the cathode 402 and stop or limit the electrochemical reaction between anode 401 and cathode 402. In some embodiments, gate 403 may be partially closed as long as there is no contact between anode 401 and cathode 402. In many embodiments, mesh screen 406 may hold metal gel 405 in place when anode 401 is moved into contact with or apart from cathode 402.

It may be appreciated to a person with ordinary skill in the art that metal gel 405 may comprise of one or more elemental metals such as, but not limited to, zinc and aluminum. Metal gel 405 may also comprise of at least one or more electrolytes such as, but not limited to, potassium hydroxide, sodium hydroxide, and lithium hydroxide. Another embodiment of the invention may have a mixture of metal gels in anode 401.

It may be appreciated to a person with ordinary skill in the art that gate 403 may be partially opened or closed to control the electrochemical reaction between anode 401 and cathode 402. Alternative embodiments of the invention may have, but not limited to, a power control system implemented by controlling the partial opening or closing of gate 403 where the contact area may be proportional to electric current generated.

It may be appreciated to a person with ordinary skill in the art that gate 403 may be implemented with different designs that do not physically block anode 401 and cathode 402 such as, but not limited to, a telescoping gate, sliding gate, rotating gate, etc. Another embodiment of the invention may have a telescoping gate that separates anode 401 and cathode 402 by increasing the physical distance between the anode 401 and cathode 402.

It may be appreciated to a person with ordinary skill in the art that mesh screen 406 and 409 may be designed to facilitate metal gels movement with the anode compartment, such that the metal gel stays in place during the separation of anode compartment and cathode compartment, and in the meantime to allow conductivity of electrolyte when anode compartment and cathode compartment are coupled. The hole size of the mesh screen may be chosen based on the properties of the metal gel. In some embodiments, the mesh size of the mesh screen may be typically above 80 mesh, preferably in the range of about 100 mesh to 200 mesh. Another embodiment of the invention may have mesh screen with different hole sizes to form an application unique anode 401 and/or cathode 402.

It may be appreciated to a person with ordinary skill in the art that a separator may be applied with or without mesh screen 406 and 409 to prevent electrolyte leakage of specific metal gels. The separator may be a physical barrier such as, but not limited to, cellulous, such as paper; nonwoven fibers such as, but not limited to, cotton, nylon, polyesters, polymer films such as, but not limited to, polyethylene, polypropylene, poly (tetrafluoroethylene), and polyvinyl chloride. Another embodiment of the invention may have separators made with different designs and/or materials to from an application unique anode 401 and/or cathode 402.

It may be appreciated to a person with ordinary skill in the art that detachable anode compartment 404 and detachable cathode compartment 407 may comprise of a plurality of detachable anode compartments and detachable cathode compartments, respectively. The plurality of compartments may be coupled in series or parallel to form one unified detachable anode compartment 404 or detachable cathode compartment 407, respectively. Another embodiment of the invention may have a plurality of different detachable anode compartments 404 or detachable cathode compartments 407 to form an application unique metal-air battery 400.

It may be appreciated to a person with ordinary skill in the art that metal-air battery 400, detachable anode compartment 401, and detachable cathode compartment 402 may be designed in any shape such as, but not limited to, a cylinder, a sphere, rectangular prism, and hexagonal prism. Another embodiment of the invention may implement metal-air battery 400 in a cube shape to allow for modular coupling of additional metal-air batteries in series or parallel.

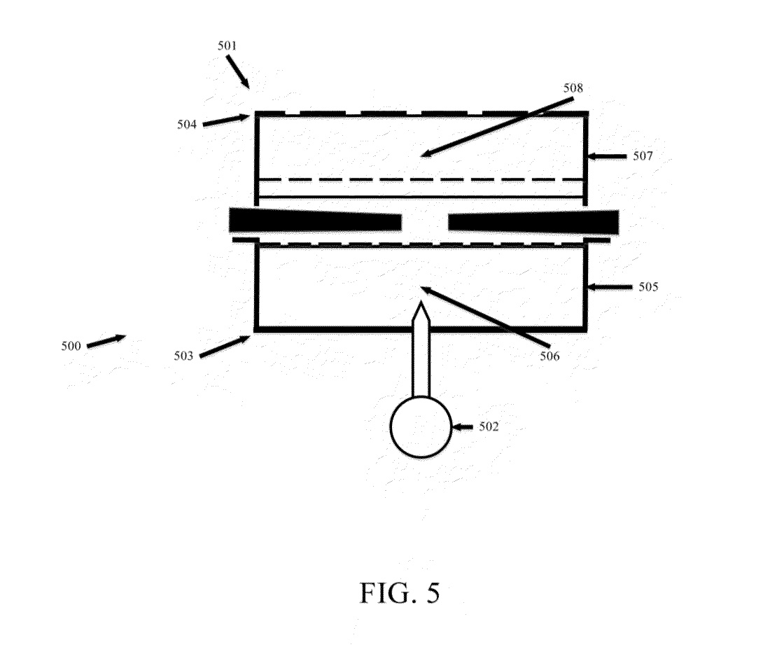

FIG. 5 illustrates an exemplary metal-air battery with an adjustable gate and injection device, in accordance with an embodiment of the present invention. Injection enabled, metal-air battery 500 comprises of metal-air battery 501 and injection device 502. Metal-air battery 501 is the metal-air battery shown in FIG. 5 and comprises of an anode 503 and a cathode 504. Anode 503 comprises of a detachable anode compartment 505 and a metal gel 506. Cathode 504 comprises of a detachable cathode compartment 507 and an electrode catalyst 508.

During typical operation, the metal gel 506 in the detachable anode compartment 505 of metal-air battery 501 may lose moisture or electrolytes over time. Injection device 502 injects water and/or an electrolyte solution through an injection port on detachable anode compartment 505.

It may be appreciated to a person with ordinary skill in the art that injection device 502 is not limited to adding water and/or an electrolyte solution. Another embodiment of the invention may inject a metal gel into detachable anode compartment 505. Still another embodiment of the invention may remove material from detachable anode compartment 505.

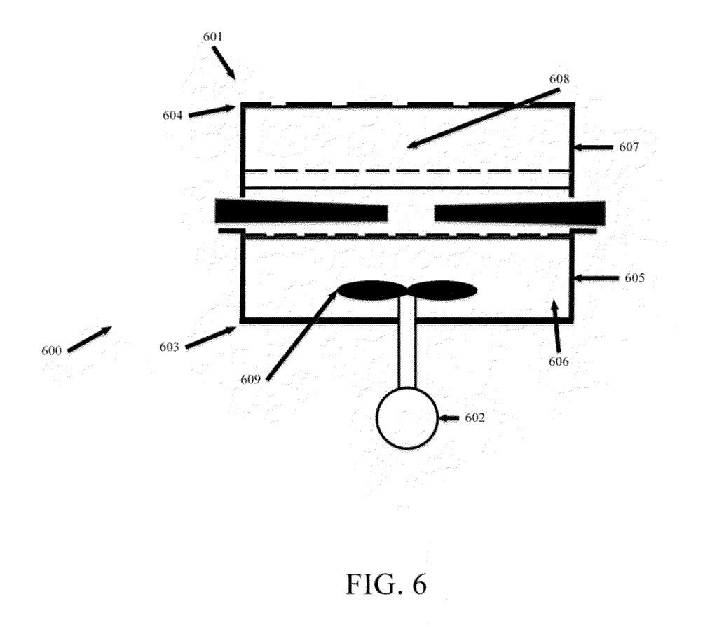

FIG. 6 illustrates an exemplary metal-air battery with an adjustable gate and stirring device, in accordance with an embodiment of the present invention. Stirring enabled, metal-air battery 600 comprises of metal-air battery 601 and stirring device 602. Metal-air battery 601 is the metal-air battery shown in FIG. 6 and comprises of an anode 603 and a cathode 604. Anode 603 comprises of a detachable anode compartment 605 and a metal gel 606. Cathode 604 comprises of a detachable cathode compartment 607 and an electrode catalyst 608. Stirring device 603 comprises of a fan-shaped agitation head 609.

During typical operation, the power output of metal-air battery 600 may decrease. Stirring device 602 initiates movement of metal gel 606 with fan-shaped agitation head 609. Power output should improve with the movement of metal gel 606.

It may be appreciated to a person with ordinary skill of the art that fan-shaped agitation head 609 may be in other shapes such as, but not limited to, a rod, a T-shape, and a spiral shaped spring. Another embodiment of the present invention may have a grated agitation head to agitate metal gel 606 with a vertical motion.

It may be appreciated to a person with ordinary skill in the art that stirring device 602 may not need to be physically manipulated outside of metal-air battery 601. Alternative embodiments of the invention may have, but not limited to, one or more magnetic agitation heads that can be controlled magnetically and electronically without direct physical contact with stirring enabled, metal-air battery 600.

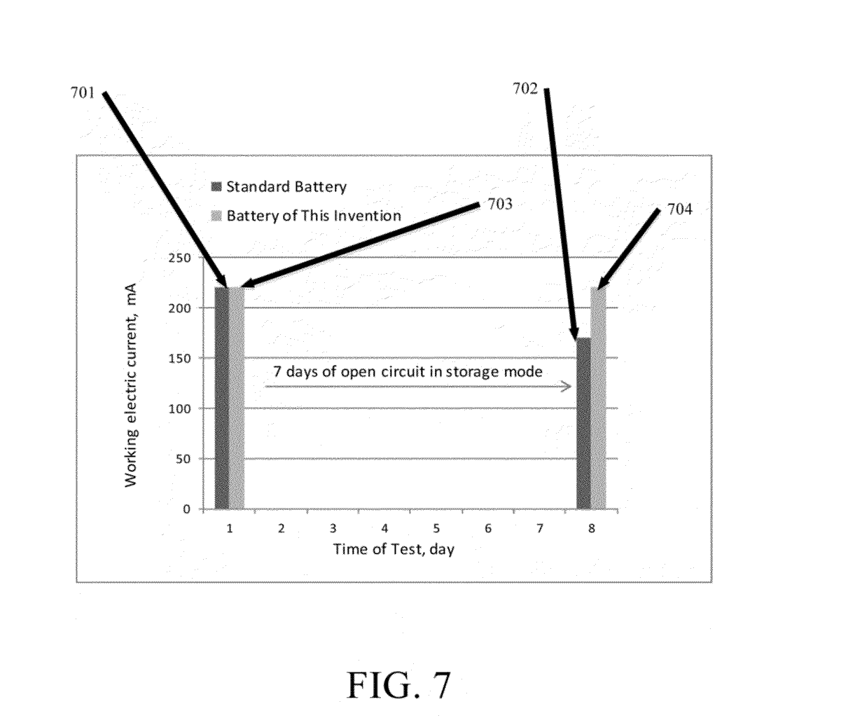

FIG. 7 is a power storage analysis, in accordance with an embodiment of the present invention. In the present non-limiting example, a typical zinc-air battery, standard battery, was tested as a base case and a zinc-air battery with separable anode and cathode compartments, battery of this invention, was tested as a test case. A current 701 was the working current for the standard battery at the beginning of the test, in which the battery is new. The battery external load was 5 Ohms. The working current 701 was at 220 mA, and the working voltage associated with 701 was at 1.2 V. After the test, the standard battery was stored as is for 1 week. Then this battery was put to test again with same external load of 5 Ohms. Current 702 was the working current for the standard battery after the battery was stored as is for 1 week. The working current 702 was at 170 mA, and the working voltage associated with 702 was at 1.0 V.

Current 703 was the working current for the battery of this invention at the beginning of the test, in which the battery is new. The battery external load was 5 Ohms. The working current 703 was at 220 mA, and the working voltage associated with 703 was at 1.2 V. After the test, the battery of this invention was stored for 1 week with anode and cathode compartment separated. Then this battery was put to test again with anode and cathode compartment compressed together. Current 704 was the working current for the battery of this invention after the battery was stored for 1 week. The working current 704 was at 220 mA, and the working voltage associated with 704 was at 1.2 V.

In another non-limiting example, a typical zinc-air battery was tested as a base case, in which a zinc gel was directly put on a separator on top of the cathode of the zinc-air battery. The cathode with an electrode catalyst had an area of about 5 cm². The electrode catalyst was a MnO₂ based catalyst supported on porous carbon. The anode of the zinc-air battery was a zinc gel with 35 wt. % potassium hydroxide as an electrolyte.

The open circuit voltage of the zinc-air battery was measured to be about 1.57 V. When the anode and cathode were electrically connected to an external load of 5 Ohms, the electric current of the zinc-air battery was about 220 mA during battery discharge. The operating voltage of the zinc-air battery was about 1.2 V. The electric current was stable for over 1 hour of operation time.

The zinc air battery was then disconnected from the external load and was left for 1 week —. The zinc air battery was then connected to the same external load of 5 Ohms. The electric current of the zinc-air battery dropped to about 170 mA during battery discharge. The operating voltage of the zinc-air battery was about 1.0 V. The cathode catalyst was observed to be wet due to the penetration of potassium hydroxide electrolyte from the anode through the separator into the cathode.

A zinc-air battery with separable anode and cathode compartments was tested as a test case. The anode compartment of the zinc-air battery had a mesh screen on the bottom of the anode compartment. The anode of the zinc-air battery contained a zinc gel electrolyte with 35 wt. % potassium hydroxide was placed on top of a mesh screen. The cathode of the zinc-air battery had an area of about 5 cm². The electrode catalyst from the cathode was a MnO₂ based catalyst supported on porous carbon.

The open circuit voltage of the zinc-air battery was also measured to be about 1.57 V. The anode compartment of the zinc-air battery was pressed onto a separator on top of the cathode so that the anode and cathode were connected. The anode and cathode were electrically connected to an external load of 5 Ohms and the electric current of the zinc-air battery was about 220 mA during battery discharge. The operating voltage of the zinc-air battery was about 1.2 V. The electric current was stable for over 1 hour of operation time. This result showed that adding a mesh screen between the anode and cathode of a zinc-air battery does not change the performance of the zinc-air battery.

The zinc-air battery was disconnected from the external load, and the anode compartment was separated from the cathode. The zinc-air battery was left in a detached mode for 1 week. The anode compartment was then pressed onto the separator on top of cathode so that the anode and cathode were connected. The zinc-air battery was then connected to the same external load of 5 Ohms. The electric current of the zinc-air battery was about 220 mA during battery discharge. The operating voltage of the zinc-air battery was about 1.2 V. The cathode catalyst was observed to be dry before the testing. This result showed that by separating the anode with cathode during storage, there was no electrolyte leakage from the anode; therefore the electrode catalyst maintained the same level of reduction activity without showing electrode catalyst deactivation due to electrolyte saturation. The results show that power storage time of a zinc-air battery is extended when the anode and cathode compartments are separated during times when the zinc-air battery is not in use.

Those skilled in the art will readily recognize, in light of and in accordance with the teachings of the present invention, that any of the foregoing steps may be suitably replaced, reordered, removed and additional steps may be inserted depending upon the needs of the particular application. Moreover, the prescribed method steps of the foregoing embodiments may be implemented using any physical and/or hardware system that those skilled in the art will readily know is suitable in light of the foregoing teachings. For any method steps described in the present application that can be carried out on a computing machine, a typical computer system can, when appropriately configured or designed, serve as a computer system in which those aspects of the invention may be embodied.

All the features disclosed in this specification, including any accompanying abstract and drawings, may be replaced by alternative features serving the same, equivalent or similar purpose, unless expressly stated otherwise. Thus, unless expressly stated otherwise, each feature disclosed is one example only of a generic series of equivalent or similar features.

It is noted that according to USA law 35 USC §112 (1), all claims must be supported by sufficient disclosure in the present patent specification, and any material known to those skilled in the art need not be explicitly disclosed. However, 35 USC §112 (6) requires that structures corresponding to functional limitations interpreted under 35 USC §112 (6) must be explicitly disclosed in the patent specification. Moreover, the USPTO's Examination policy of initially treating and searching prior art under the broadest interpretation of a “mean for” claim limitation implies that the broadest initial search on 112(6) functional limitation would have to be conducted to support a legally valid Examination on that USPTO policy for broadest interpretation of “mean for” claims. Accordingly, the USPTO will have discovered a multiplicity of prior art documents including disclosure of specific structures and elements which are suitable to act as corresponding structures to satisfy all functional limitations in the below claims that are interpreted under 35 USC §112 (6) when such corresponding structures are not explicitly disclosed in the foregoing patent specification. Therefore, for any invention element(s)/structure(s) corresponding to functional claim limitation(s), in the below claims interpreted under 35 USC §112 (6), which is/are not explicitly disclosed in the foregoing patent specification, yet do exist in the patent and/or non-patent documents found during the course of USPTO searching, Applicant(s) incorporate all such functionally corresponding structures and related enabling material herein by reference for the purpose of providing explicit structures that implement the functional means claimed. Applicant(s) request(s) that fact finders during any claims construction proceedings and/or examination of patent allowability properly identify and incorporate only the portions of each of these documents discovered during the broadest interpretation search of 35 USC §112 (6) limitation, which exist in at least one of the patent and/or non-patent documents found during the course of normal USPTO searching and or supplied to the USPTO during prosecution. Applicant(s) also incorporate by reference the bibliographic citation information to identify all such documents comprising functionally corresponding structures and related enabling material as listed in any PTO Form-892 or likewise any information disclosure statements (IDS) entered into the present patent application by the USPTO or Applicant(s) or any 3^{rd} parties. Applicant(s) also reserve its right to later amend the present application to explicitly include citations to such documents and/or explicitly include the functionally corresponding structures which were incorporate by reference above.

Thus, for any invention element(s)/structure(s) corresponding to functional claim limitation(s), in the below claims, that are interpreted under 35 USC §112 (6), which is/are not explicitly disclosed in the foregoing patent specification, Applicant(s) have explicitly prescribed which documents and material to include the otherwise missing disclosure, and have prescribed exactly which portions of such patent and/or non-patent documents should be incorporated by such reference for the purpose of satisfying the disclosure requirements of 35 USC §112 (6). Applicant(s) note that all the identified documents above which are incorporated by reference to satisfy 35 USC §112 (6) necessarily have a filing and/or publication date prior to that of the instant application, and thus are valid prior documents to incorporated by reference in the instant application.

Having fully described at least one embodiment of the present invention, other equivalent or alternative methods of implementing a metal-air battery system according to the present invention will be apparent to those skilled in the art. Various aspects of the invention have been described above by way of illustration, and the specific embodiments disclosed are not intended to limit the invention to the particular forms disclosed. The particular implementation of the metal-air battery system may vary depending upon the particular context or application. By way of example, and not limitation, the metal-air battery system described in the foregoing were principally directed to separable anode and cathode compartment implementations; however, similar techniques may instead be applied to implementations requiring control of contact between two objects such as power management systems, braking systems, and laboratory equipment, which implementations of the present invention are contemplated as within the scope of the present invention. The invention is thus to cover all modifications, equivalents, and alternatives falling within the spirit and scope of the following claims. It is to be further understood that not all of the disclosed embodiments in the foregoing specification will necessarily satisfy or achieve each of the objects, advantages, or improvements described in the foregoing specification.

Claim elements and steps herein may have been numbered and/or lettered solely as an aid in readability and understanding. Any such numbering and lettering in itself is not intended to and should not be taken to indicate the ordering of elements and/or steps in the claims.

The corresponding structures, materials, acts, and equivalents of all means or step plus function elements in the claims below are intended to include any structure, material, or act for performing the function in combination with other claimed elements as specifically claimed.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

The Abstract is provided to comply with 37 C.F.R. Section 1.72(b) requiring an abstract that will allow the reader to ascertain the nature and gist of the technical disclosure. It is submitted with the understanding that it will not be used to limit or interpret the scope or meaning of the claims. The following claims are hereby incorporated into the detailed description, with each claim standing on its own as a separate embodiment.

What is claimed is:

1. A metal-air battery comprising:
an anode portion comprising at least a metal gel and an electrolyte;
a mesh screen being disposed on said anode portion, said mesh screen being configured for substantially holding said metal gel within said anode portion;
a cathode portion comprising at least a current carrier and a cathode catalyst;
a separator being disposable between said anode portion and said cathode portion for mitigating leakage of said electrolyte; and
a gate device being disposed between said anode portion and said cathode portion, said gate device comprising an open state to enable a contact of said anode portion and said cathode portion for activating a generation of electrical power, and a closed state to separate the contact of said anode portion and said cathode portion to inhibit the generation of electrical power for storing the metal-air battery.

2. The metal-air battery as recited in claim 1, further comprising an injection device being configured for injecting water and/or an electrolyte solution into said anode portion.

3. The metal-air battery as recited in claim 1, further comprising a stirring device being configured for stirring said metal gel.

4. The metal-air battery as recited in claim 1, in which said gate device physically separates said anode portion and said cathode portion.

5. The metal-air battery as recited in claim 1, in which said gate device further comprises a shutter type design.

6. The metal-air battery as recited in claim 1, in which said anode portion and said cathode portion are configured to be detachable.

7. The metal-air battery as recited in claim 1, in which said metal gel comprises at least one of a zinc gel or aluminum gel.

8. The metal-air battery as recited in claim 1, in which said electrolyte comprises a one of potassium hydroxide, sodium hydroxide or lithium hydroxide.

9. The metal-air battery as recited in claim 1, in which said mesh screen comprises a non-conductive material.

10. The metal-air battery as recited in claim 1, in which said mesh screen comprises a mesh range of about 100 to 200 mesh.

11. The metal-air battery as recited in claim 1, in which said gate device is adjustable between said open state and said closed state.

12. The metal-air battery as recited in claim 3, in which said stirring device comprises a fan-shaped agitation head.

13. The metal-air battery as recited in claim 1, in which the metal-air battery further comprises geometries for modular coupling of additional metal-air batteries in series or parallel.

14. A metal-air battery comprising:
an anode portion comprising at least a metal gel and an electrolyte;
means for holding said metal gel within said anode portion;
a cathode portion comprising at least a current carrier and a cathode catalyst;
means for mitigating leakage of said electrolyte; and
means for activating a generation of electrical power and for storing the metal-air battery.

15. The metal-air battery as recited in claim 14, further comprising means for injecting water and/or an electrolyte solution into said anode portion.

16. The metal-air battery as recited in claim 14, further comprising means for stirring said metal gel.

17. A metal-air battery comprising:
an anode portion comprising at least a metal gel and an electrolyte, said anode portion being configured to be detachable;
a mesh screen being disposed on said anode portion, said mesh screen being configured for substantially holding said metal gel within said anode portion, said mesh screen comprising a non-conductive material having a mesh range of about 100 to 200 mesh;
a cathode portion comprising at least a current carrier and a cathode catalyst, said cathode portion being configured to be detachable;
a separator being disposable between said anode portion and said cathode portion for mitigating leakage of said electrolyte;
an injection device being configured for injecting water and/or an electrolyte solution into said anode portion;
a stirring device comprising a fan-shaped agitation head for stirring said metal gel; and
a gate device being disposed between said anode portion and said cathode portion, said gate device comprising a shutter type design having an open state to enable a contact of said anode portion and said cathode portion for activating a generation of electrical power, and a closed state to physically separate the contact of said anode portion and said cathode portion to inhibit the generation of electrical power for storing the metal-air battery, said gate device being operable to be adjustable between said open state and said closed state, wherein the metal-air battery further comprises geometries for modular coupling of additional metal-air batteries in series or parallel.

18. The metal-air battery as recited in claim 17, in which said metal gel comprises at least one of a zinc gel or aluminum gel.

19. The metal-air battery as recited in claim 17, in which said electrolyte comprises a one of potassium hydroxide, sodium hydroxide or lithium hydroxide.
